(19) United States
(12) Patent Application Publication
(10) Pub. No.: US 2018/0331518 A1
(43) Pub. Date: Nov. 15, 2018

(54) SYSTEM AND METHOD FOR LAYING CABLES AND THE LIKE THROUGH FLUID PIPES

(71) Applicant: CRALEY GROUP LIMITED, Hampshire (GB)

(72) Inventor: Michael PARKER, Hampshire (GB)

(21) Appl. No.: 15/776,586

(22) PCT Filed: Nov. 11, 2016
(86) PCT No.: PCT/GB2016/053541

§ 371 Date: May 16, 2018

(30) Foreign Application Priority Data
Nov. 13, 2015 (GB) 1520036.3

(51) Int. Cl. H02G 1/08; F16L 7/02

(52) U.S. Cl. CPC H02G 1/086; F16L 7/02; H02G 1/081

(57) ABSTRACT

A pipe (100) comprises a first connector fitting (102) and a second connector fitting (104) downstream of the first. The fluid pressure within the pipe (100) is substantially equalised to the air pressure within the first connector fitting (102). Then a draw wire (4), fitted with a sail structure (6) is inserted through the first connector fitting (102). Fluid flow within the pipe (100) acts upon the sail structure 6 to move the draw wire (4) along the pipe (100) in towards the second connector fitting (104) where an extraction member (108) is inserted. The extraction member (108) is used to withdraw the draw wire (14) through the second connector fitting (104). The draw wire (4) is attached to a first end of a micro-duct (110) and thus a pulling mechanism (114) can act on the draw wire 4 to introduce the micro-duct (110) into the pipe (100) between the connector fittings (102, 104).

### TECHNICAL FIELD OF THE INVENTION

The present invention relates to a system and method for laying cables and the like through fluid pipes, such as water or waste water pipes, for example.

### BACKGROUND TO THE INVENTION

It is known in the art to utilise pre-existing fluid pipes, such as those commonly used for water, waste water, sewage or gas, for example, as conduits through which new cables are introduced. In this way it is possible to provide new cable systems, or upgrade existing cable systems, without the need for the installation of overhead cables or further excavation to lay the new cables in dedicated conduits. Systems of this type therefore tend to be much less expensive and are less disruptive in cases where a cable system may pass across a public highway, or private land, which would otherwise have to be excavated to lay additional conduits.

Whilst these systems provide the above-mentioned advantages, there are associated drawbacks. Given that the cables are introduced into live fluid pipes, it is necessary to isolate the section of pipe through which the cable is inserted during the installation process. By isolating pipes of this type you inevitably prevent fluid from traveling downstream which leads to inconvenient interruptions in the supply of the fluid to the end user. In some instances, these interruptions may be present for a prolonged period of time which may not be acceptable.

It would therefore be advantageous to provide a system and method for laying cables through fluid pipes in which the installation of the cable/s, or micro-duct/s into which the cable/s are subsequently located, takes place whilst the fluid pipe is live and pressurised.

It is an aim of an embodiment or embodiments of the invention to at least partially overcome the problems associated with prior art systems.

### SUMMARY OF THE INVENTION

According to a first aspect of the present invention there is provided a method of laying one or more elongate flexible members through a fluid pipe comprising the steps of:
a) inserting a first end of draw wire into the fluid pipe through a first opening in the fluid pipe;
b) allowing the draw wire to travel along the pipe under the influence of the fluid flow through the pipe;
c) withdrawing the first end of the draw wire from the pipe through a second opening in the pipe such that the first end of the draw wire is located at the second opening, outside of the pipe; a second end of the draw wire is located at the first aperture, outside of the pipe; and an intermediary portion of the draw wire is located between the first and second ends of the draw wire within the pipe;
d) attaching a first end of the or each elongate flexible member to the second end of the draw wire; and
e) moving the draw wire through the pipe in a direction from the first opening towards the second opening to transfer the or each elongate flexible member through the pipe and subsequently out of the pipe through the second opening such that the or each elongate flexible member has a first end which is located at the second opening, outside of the pipe; an intermediary portion located within the pipe between the first and second openings; and the remainder of the or each elongate member is located at the first opening, outside of the pipe.

The method of the invention allows for the insertion of the draw wire, and subsequent insertion of the or each elongate flexible member whilst the fluid pipe is live. In this way, the length of time for which the fluid pipe is not live during installation of flexible members in fluid pipes is drastically reduced and in some cases eliminated. This reduces the knock-on effect to the end users of fluid travelling through these pipes.

In some embodiments at least one of the one or more elongate flexible members may comprise a cable. Additionally or alternatively, at least one of the one or more elongate flexible members may comprise a micro-duct. In such embodiments, the method may additionally comprise the step of introducing at least one cable into the or each micro-duct subsequent to step e). The at least one cable may be blown along the micro-duct. This can be achieved using conventional cable blowing techniques.

In some embodiments the draw wire may be provided with a sail structure. This can aid the movement of the draw wire along the pipe under the influence of the fluid flow within the pipe. The sail structure may be attached to or integrally formed with the draw wire. In embodiments wherein the sail structure is attached to the draw wire, the sail structure may additionally comprise a connection means operable to attach the draw wire thereto.

In some embodiments the sail structure comprises a surface which is positioned in use at an angle to the direction of fluid flow along the pipe. In such embodiments the method comprises allowing the draw wire to move along the length of the pipe by means of the fluid within the pipe acting on said surface.

In embodiments wherein the sail structure comprises a surface, the surface may comprise a net or web having a plurality of apertures located therein. Alternatively, the surface may comprise a continuous sheet.

The method may further comprise collapsing the sail structure from an expanded configuration to a collapsed configuration. In such embodiments the sail structure may be collapsed in order to insert or remove it from the pipe through the first and/or second openings. In further embodiments the method may comprise expanding the sail structure from a collapsed position to an expanded position.

Preferably, the sail structure is operable to move between a collapsed configuration and an expanded configuration. In the collapsed configuration the sail structure may be collapsed into an elongate narrow form. Such a configuration may facilitate insertion or withdrawal of the sail structure through the first and/or second openings in the pipe. In the expanded form, the sail structure may be expanded into a relatively wide structure adapted to be influenced by the fluid flow through the pipe. In some embodiments the method comprises collapsing the sail structure to its collapsed position upon insertion or withdrawal of the sail structure into/out of the pipe. In such embodiments, the method may subsequently comprise expanding the sail structure after insertion of the sail structure into the pipe, i.e. when the sail structure is within the pipe.

The method may comprise collapsing and/or expanding the movement mechanism under the operation of an actuation means. The actuation means may be acted upon by a user to expand or collapse the sail structure. Alternatively, the actuation means may be automated. In such embodiments, the sail structure may collapse automatically when inserting or removing the sail structure into/from the pipe, and may automatically expand once located within the pipe.

In some embodiments the method comprises inserting the draw wire and sail structure through the first opening in the pipe with the sail structure in its collapsed position, and subsequently expanding the sail structure to its expanded position when inside the pipe.

Withdrawing the first end of the draw wire from within the pipe through the second opening may be achieved under the operation of a withdrawal means. The withdrawal means may comprise an extraction member. In such cases, the method comprises inserting the extraction member through the second opening and subsequently engaging a portion of the draw wire to connect therewith for withdrawal of the first end of the draw wire from the interior of the pipe.

The method may comprise installing one or more connector fittings on the pipe. The or each connector fitting may provide the first and/or second openings in the pipe. The method may comprise installing the or each connector fitting before performing step a).

In some embodiments, the or each connector fitting may comprise a pressure chamber. In such embodiments, the method may comprise utilising the or each pressure chamber to equalise the fluid pressure within the pipe to the air pressure within the connector fitting.

In some embodiments the first and/or second openings in the pipe may initially be sealed by means of the or each connector fitting. In such embodiments the method may comprise equalising the fluid pressure within the pipe with the air pressure within the connector fitting before removing the seal from the opening/s. In this way, the laying of the cable/s through the pipe can be performed whilst the fluid pipe is live and pressurised without fluid being expelled from the pipe.

In some embodiments step e) of the method may be performed under the operation of the or each connector fitting by either pulling or pushing the draw wire and/or one or more elongate flexible members along the length of the pipe subsequent to the first end of the draw wire being withdrawn from the pipe through the second opening.

In some embodiments the method comprises monitoring the position of the draw wire as it is allowed to move along the length of the fluid pipe. In such embodiments, the method may comprise monitoring the position of the draw wire using a transmitter, such as a radio transmitter, for example. To facilitate such operation, the transmitter may be attached to the draw wire. Preferably, the transmitter is attached at or close to the first end of the draw wire. Alternatively, the transmitter may be attached to the sail structure. Additionally or alternatively the method may comprise tracking the location of the draw wire using a camera provided within the pipe.

The method may additionally comprise sterilising the draw wire and/or the one or more flexible members. The sterilisation of the draw wire and/or flexible member/s may be performed during the insertion process. Alternatively, the sterilisation process may be undertaken separately before the insertion process is begun. In embodiments wherein the sterilisation process is undertaken during the insertion process, the method may comprise passing the draw wire and/or flexible member/s through a sterilisation mechanism before inserting the draw wire/flexible member(s) into the pipe.

The sterilisation mechanism may comprise a sterilisation chamber which may be filled with a fluid. In some embodiments the fluid comprises water enriched with O₃ molecules (known as ozone gas). In such embodiments, the method may additionally comprise supplying ‘ozone gas’ to a fluid within the sterilisation chamber during the insertion process. Alternatively, the method may additionally comprise supplying ozone gas dry. By dry, it is meant that the ozone gas is used without an intermediary fluid to carry it. In further embodiments alternative sterilisation techniques or chemical means may be employed to achieve said sterilisation.

According to a second aspect of the present invention there is provided a sail structure for use in the method of the first aspect of the present invention comprising a surface and a means to connect the sail structure to a draw wire, in use.

The sail structure may be operable to aid in the movement of a connected draw wire along a fluid pipe under the influence of the fluid flow through the pipe.

In some embodiments the sail structure surface is positioned in use at an angle to the direction of fluid flow along the pipe. In this way, the fluid moving along the pipe acts upon this surface resulting in the sail structure, and hence the connected draw wire, being moved along the pipe in the direction of the fluid flow. The sail structure is preferably located at and connected to the first end of the draw wire, in use.

In some embodiments the sail structure may be configured such that the surface is positioned substantially perpendicular to the direction of fluid flow through the pipe. In other embodiments the structure may comprise a spherical cap may be conical or frustoconical narrowing from a first end to a second end in the direction of fluid flow along the pipe, the surface taking the shape of the structure.

In some embodiments the sail structure surface may be a net or web having a plurality of apertures located therein. Alternatively, the surface may comprise a continuous sheet.

The sail structure may be collapsible from an expanded configuration to a collapsed configuration. In such embodiments the sail structure may be collapsed in order to insert or remove it from the pipe through the first and/or second openings. In further embodiments the sail structure may be expandable from a collapsed position to an expanded position.

Preferably, the sail structure is operable to move between a collapsed configuration and an expanded configuration. In the collapsed configuration the sail structure may be collapsed into an elongate narrow form. Such a configuration may allow insertion or withdrawal of the sail structure through the first and/or second openings in the pipe. In the expanded form, the sail structure may be expanded into a relatively wide structure adapted to be influenced by the fluid flow through the pipe.

In some embodiments in its collapsed configuration the structure may be substantially cylindrical, and may comprise a cross-sectional diameter which is equal to, less than or more than the cross-sectional diameter of the pipe internal diameter. In preferred embodiments the cross-sectional diameter of the structure in its collapsed configuration is less than or equal to the cross-sectional diameter of the draw wire. In this way, the size of the first and second openings in the pipe may be kept to a minimum.

The system may additionally comprise an actuation means operable in use to control the collapse/expansion of the sail structure. The actuation means may be acted upon by a user to expand or collapse the sail structure, or alternatively, the actuation means may comprise an automated actuation means. In such embodiments, the sail structure may be operable in use to collapse automatically when it is inserted into or removed from the pipe, and automatically expand once located within the pipe.

In some embodiments the sail structure is retained in its expanded configuration under the operation of a biasing means. The biasing means may comprise an annular stiffening ring. The annular stiffening ring may be configured such that it is biased towards a generally circular shape. In such embodiments, the sail structure may be configured such that it collapses when moving through the first and/or second opening by means of moving the annular stiffening ring against said bias.

In some embodiments the sail structure may collapse when being pushed through the first opening and/or pulled through the second opening automatically when contacting the portion of the pipe defining each opening, and expand to its expanded configuration when inside the pipe. To achieve this, the sail structure may additionally comprise a first set of at least two supporting arms. In some embodiments the first set of supporting arms are connected at a first end to at least one other of the two or more supporting arms and at a second end to the annular stiffening ring. In some embodiments the supporting arms are generally straight such that the supporting arms and annular stiffening ring define a substantially conical configuration when the sail structure is in its expanded configuration with the apex of the formed cone being located at the front of the system with respect to the direction of fluid flow along the pipe. Alternatively, the first set of supporting arms may be curved somewhat such that the supporting arms and annular stiffening ring define a substantially hemispherical configuration when the sail structure is in its expanded configuration with the apex of the formed hemisphere being located at the front of the system with respect to the direction of fluid flow along the pipe. In either case, the first set of supporting arms is configured to act upon the annular stiffening ring upon application of a force in an inward direction with respect to the conical/hemispherical configuration of the set. This inward force may be provided by means of contact of at least one of the supporting arms making up the first set with the portion of the pipe defining each opening.

In further embodiments the sail structure is configured such that it collapses when being pulled through the first opening. In this way, after insertion of the sail structure into the pipe through the first opening, it is possible to subsequently remove the mechanism, and connected draw wire, back through the first opening if required. To achieve this, the sail structure may further comprise a second set of two or more supporting arms. This second set of supporting arms may be configured in a similar way to the first set but in an opposite orientation, i.e. with the apex of the formed cone/hemisphere being located at the back of the system with respect to the direction of fluid flow along the pipe. In this way, the first set of supporting arms may act to collapse the sail structure when pushing the structure through the first opening, and the second set of supporting arms may act to collapse the sail structure when pulling the structure through the first opening.

In embodiments comprising at least one set of supporting arms in addition to a surface, the sail structure surface may comprise a canopy which is connected to or integrally formed with at least a portion of one or more of the supporting arms making up at least one of the sets. In some embodiments the surface comprises a canopy which is connected to or integrally formed with all of the supporting arms making up both the first and second sets. In presently preferred embodiments, the surface comprises a canopy which is connected to or integrally formed with each of the supporting arms making up the first set, only.

The sail structure may additionally comprise at least one flow aperture located therein. In some embodiments the at least one flow aperture is located within the surface of the sail structure. In such embodiments, the or each flow aperture may be provided in addition to any further apertures located within the surface, for example, in embodiments wherein the surface comprises a web or net. The or each flow aperture may be centralised on the surface. For example, in embodiments wherein the structure is conical in shape and the surface of the sail structure takes the shape of the structure, the surface may comprise a single aperture at the apex of the cone-shaped surface.

In use, the or each flow aperture may act to centralise the sail structure within the fluid flow to prevent the structure from contacting the pipe lining and restricting motion of a connected draw wire therealong. Additionally or alternatively, the sail structure may be constructed of a material or materials which have a substantially neutral buoyancy within the fluid in the pipe, or may additionally comprise one or more floatation devices in order to prevent/reduce any contact between the mechanism and the pipe lining, in use.

According to a third aspect of the present invention there is provided an extraction member for use in the method of the first aspect of the present invention comprising a body which is operable in use to be inserted through the second opening in the pipe, the body having a surface thereon operable to engage a portion of the draw wire and/or sail structure for subsequent withdrawal of the first end of the draw wire from within the interior of the pipe.

In some embodiments the surface of the member for engagement with the portion of the draw wire and/or sail structure may comprise a hook or loop and the draw wire or sail structure may additionally comprise a corresponding loop or hook. In further embodiments, the surface of the member may comprise a magnet or series of magnets and the draw wire or sail structure may comprise a portion which is formed of a magnetic material. Alternatively, the surface may be formed from a magnetic material and the draw wire or sail structure may comprise a magnet or series of magnets thereon.

The extraction member may additionally comprise a means to view along the length of the pipe when it is inserted through the second opening. The viewing means may comprise a camera permanently or temporarily connected to a portion of the extraction member.

In some embodiments the extraction member may additionally comprise an illumination means. The illumination means may be positioned such that it illuminates at least a portion of the interior of the pipe in use. The illumination means may be permanently or temporarily connected to the body of the extraction member.

In some embodiments the body of the extraction member comprises at least one bore. The at least one bore may be dimensioned to receive either the viewing means or the illumination means. In such embodiments the viewing means and/or illumination means may comprise a shaft dimensioned to be received within the or each bore, in use. To accommodate locating the viewing means and/or illumination means, the or each bore may comprise an open end. Similarly, the or each bore may additionally comprise a viewing aperture which may be seat a distal end of the bore to the open end through which either the viewing means may view the interior of the pipe, or the illumination means may illuminate the interior of the pipe, in use. In some embodiments there is provided more than one bore and in presently preferred embodiments there is provided two bores, one for each of the viewing means and illumination means.

According to a fourth aspect of the present invention there is provided a connector fitting for use in the method in accordance with the first aspect of the present invention, the connector fitting comprising an attachment means adapted to attach to a surface of the fluid pipe about an opening within the pipe; and a sealing means for providing a watertight seal around the opening.

The connector fitting may be operable in use to allow for the introduction or removal of a draw wire and/or one or more elongate flexible members into or out of the interior of the pipe through the opening in the pipe. In such embodiments, the sealing means may be operable to maintain the watertight seal once the draw wire and/or one or more elongate flexible members have been introduced/removed from the pipe, and/or during the introduction or removal of the draw wire and/or one or more elongate flexible members.

In some embodiments, the connector fitting may additionally comprise a pressure chamber. The pressure chamber may be operable in use to equalise the fluid pressure within the pipe to the air pressure within the connector fitting. In this way, the laying of the cable/s through the pipe can be performed whilst the fluid pipe is live and pressurised without fluid being expelled from the pipe.

The pressure chamber may be releasably connected to the connector fitting or may be integrally formed with the connector fitting. In embodiments wherein the pressure chamber is releasably connected to the connector fitting, the pressure chamber and connector fitting each include an attachment means for providing the releasable connection.

The pressure chamber may additionally comprise a sealed opening through which a draw wire and/or one or more elongate flexible members may be introduced, passed through the pressure chamber into the connector fitting and subsequently into the interior of the pipe.

The connector fitting may further comprise a push or pull mechanism which is operable in use to either pull or push the draw wire and/or one or more elongate flexible members along the length of the pipe. In use, this may be performed subsequent to the first end of the draw wire being withdrawn from the pipe through the second opening.

According to a fifth aspect of the present invention there is provided a kit of parts for performing the method laying one or more elongate flexible members through a fluid pipe in accordance with the first aspect of the present invention comprising a sail structure in accordance with the second aspect of the present invention; and a draw wire.

The fifth aspect of the present invention may incorporate any or all of the features of the first and second aspects of the invention as is desired or appropriate.

The kit of parts may be used to perform the method in accordance with the first aspect of the present invention by laying one or more elongate flexible members through a fluid pipe which comprises a first opening at a first point on the pipe, and a second opening at a second point on the pipe, the second opening being located downstream of the first opening.

In some embodiments the kit additionally comprises a means to withdraw a leading first end of the draw wire from within the pipe through the second opening. The withdrawal means may comprise an extraction member operable in use to be inserted through the second opening and subsequently engage a portion of the draw wire to connect therewith for withdrawal of the first end of the draw wire from the interior of the pipe. Alternatively, the withdrawal means may be operable in use to be inserted through the second opening in the pipe and subsequently engage a portion of the sail structure to connect therewith for withdrawal of the sail structure and a connected draw wire from within the interior of the pipe. The extraction member may be an extraction member in accordance with the third aspect of the present invention

In some embodiments the member may comprise a hook or loop and the draw wire or sail structure may additionally comprise a corresponding loop or hook. In further embodiments, the member may comprise a magnet or series of magnets and the draw wire or sail structure may comprise a portion which is formed of a magnetic material. Alternatively, the member may comprise a portion which is formed from a magnetic material and the draw wire or sail structure may comprise a magnet or series of magnets thereon.

The kit of parts may additionally comprise an insertion mechanism operable in use to insert the draw wire and/or sail structure into the pipe. The insertion mechanism may comprise one or more connector fittings, the connector fittings being able to be connected to or installed as part of the pipe. The or each connector fitting may comprise any or all of the features of the connector fitting of the fourth aspect of the present invention as required or desired.

The or each connector fitting may provide the first and/or second openings in the pipe. In some embodiments the first and/second opening in the pipe is sealable. The or each connector fitting may provide this seal.

In some embodiments, the or each connector fitting may additionally comprise a pressure chamber. The or each pressure chamber may be operable in use to equalise the fluid pressure within the pipe to the air pressure within the connector fitting. In this way, the laying of the cable/s through the pipe can be performed whilst the fluid pipe is live and pressurised without fluid being expelled from the pipe.

The or each connector fitting may be further operable in use to either pull or push the draw wire and/or one or more elongate flexible members along the length of the pipe subsequent to the first end of the draw wire being withdrawn from the pipe through the second opening. For example, there may be provided a first pressure chamber at a first connector fitting which is located at the first opening in the pipe and is operable in use to push the draw wire and/or one or more elongate flexible members which are attached to the draw wire in a direction along the length of the pipe. Likewise, there may be provided a second pressure chamber at a second connector fitting located at the second opening within the pipe which may be operable in use to pull the draw wire and/or one or more elongate flexible members which are attached to the draw wire in a direction along the length of the pipe. In this way, subsequent to passing the draw wire along the pipe from the first opening to the second opening, the system provides a means to lay one or more elongate flexible members within the pipe.

The draw wire may additionally comprise a means to attach one or more elongate flexible members to an end thereof. In this way, subsequent to withdrawing the first end of the draw wire at the second connector fitting, one or more elongate flexible members can be attached to the opposing end of the draw wire for subsequent introduction into the interior of the pipe.

The one or more elongate flexible members may comprise a cable or in some embodiments may comprise a micro-duct into which one or more cables may be introduced. In such embodiments, the system may additionally comprise a means to blow one or more cables along one or more micro-ducts within the pipe.

The kit of parts may additionally comprise a transmitter, such as a radio transmitter, for example. In some embodiments the transmitter may be a sonde or micro-sonde. The transmitter may be located at a point along the draw wire. In presently preferred embodiments the transmitter is located at the first end of the draw wire. In this way the position of the draw wire can be monitored and its progression along the pipe can be tracked, in use. The transmitter may be formed integrally with the draw wire, or may be attached thereto. Alternatively, the transmitter may be provided as part of or connected to the sail structure.

In some embodiments the transmitter may be configured to have a neutral buoyancy within the fluid which flows through the pipe. This buoyancy may be provided with one or more floatation devices, such as floatation balls, connected to the transmitter. Alternatively, the buoyancy of the transmitter may be a feature of the transmitter itself without the need for additional floatation devices.

In addition to the transmitter the kit of parts may comprise one or more additional means to track the location of the draw wire within the pipe. For example, there may be provided a camera for obtaining images/videos from within the pipe, in use. The camera may be provided on the draw wire, such as on the structure or combined with a transmitter. Alternatively, the camera may form part of the extraction member. In this way, the location of the draw wire within the pipe may be tracked initially by use of a transmitter and subsequently through the use of the camera. This is particularly advantageous as it provides greater control over the operation of the extraction member as a user will be able to view inside the pipe when looking to remove the draw wire through the second opening within the pipe.

### DETAILED DESCRIPTION OF THE INVENTION

In order that the invention may be more clearly understood an embodiment thereof will now be described, by way of example only, with reference to the accompanying drawings, of which:

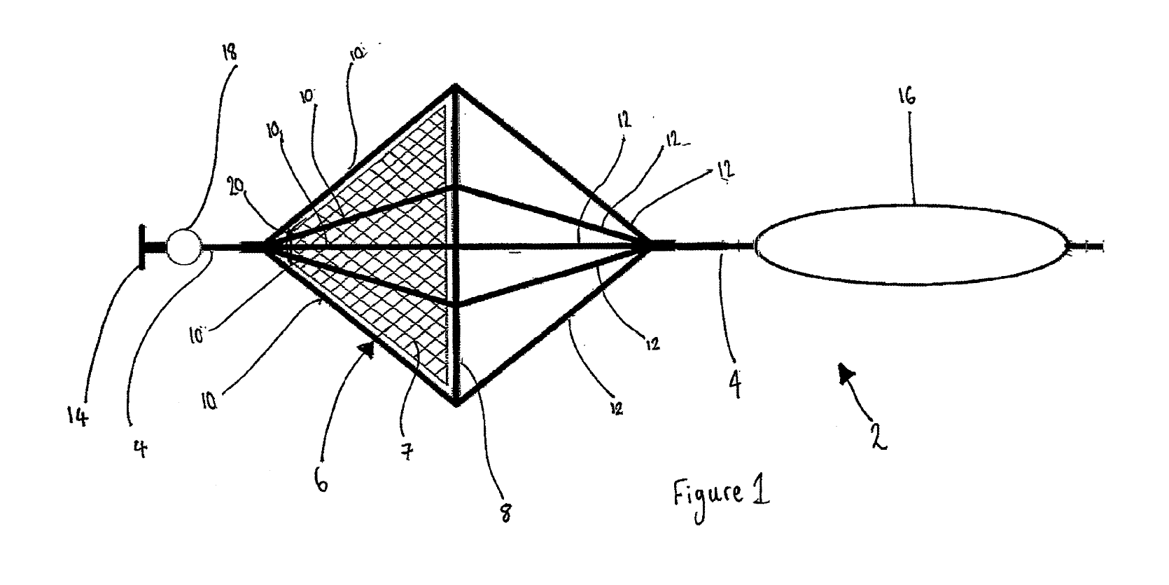

FIG. 1 is a schematic side cross-sectional view of a section of a system in accordance with the second aspect of the present invention;

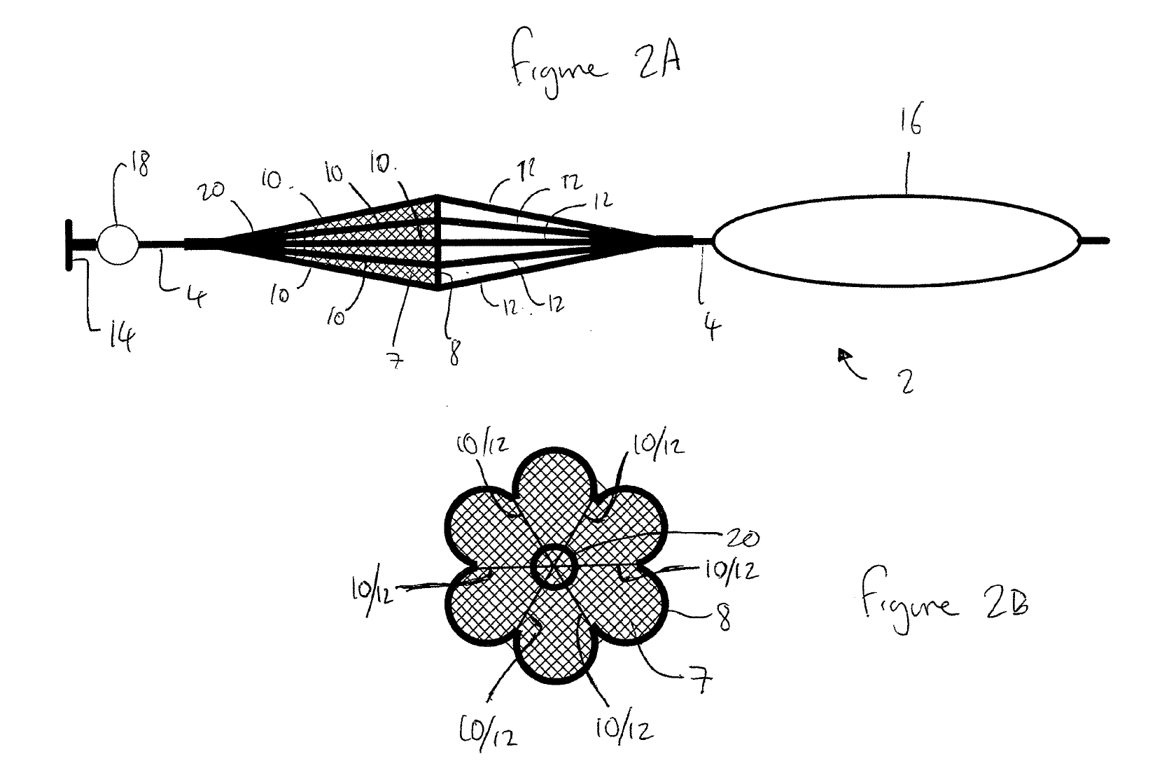

FIG. 2A is a schematic side cross-sectional view of the section of the system of FIG. 1 with the sail structure in a collapsed configuration;

FIG. 2B is a schematic end view of the section of the collapsed configuration of the sail structure of FIG. 2A;

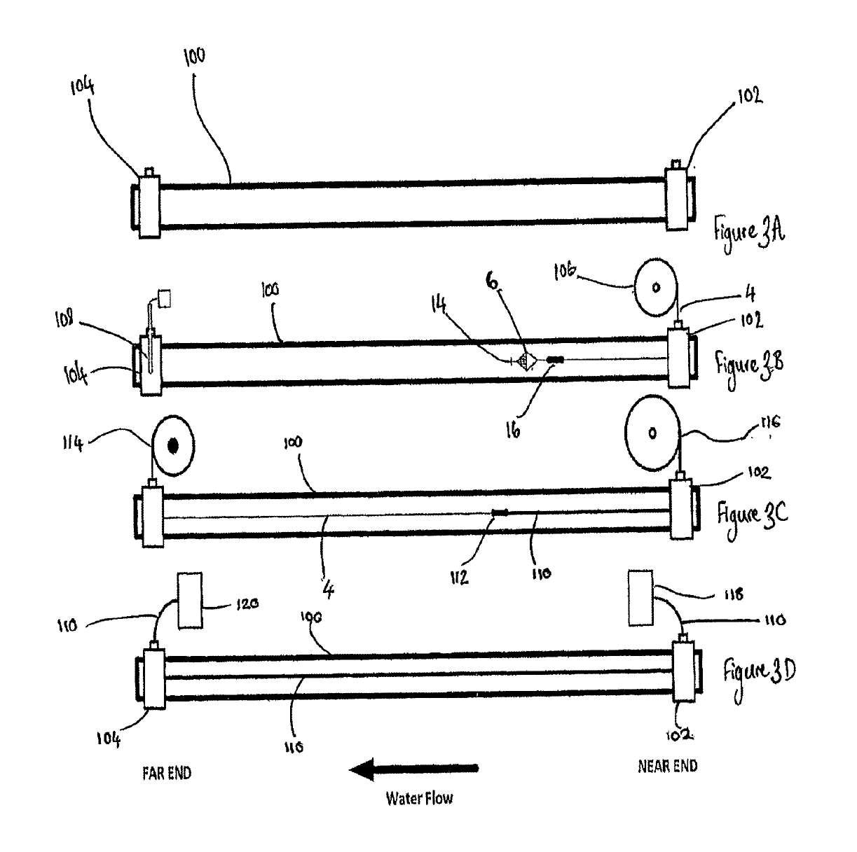

FIGS. 3A-3D are a series of schematic side cross-sectional views of a pipe illustrating the method in accordance with the first aspect of the present invention;

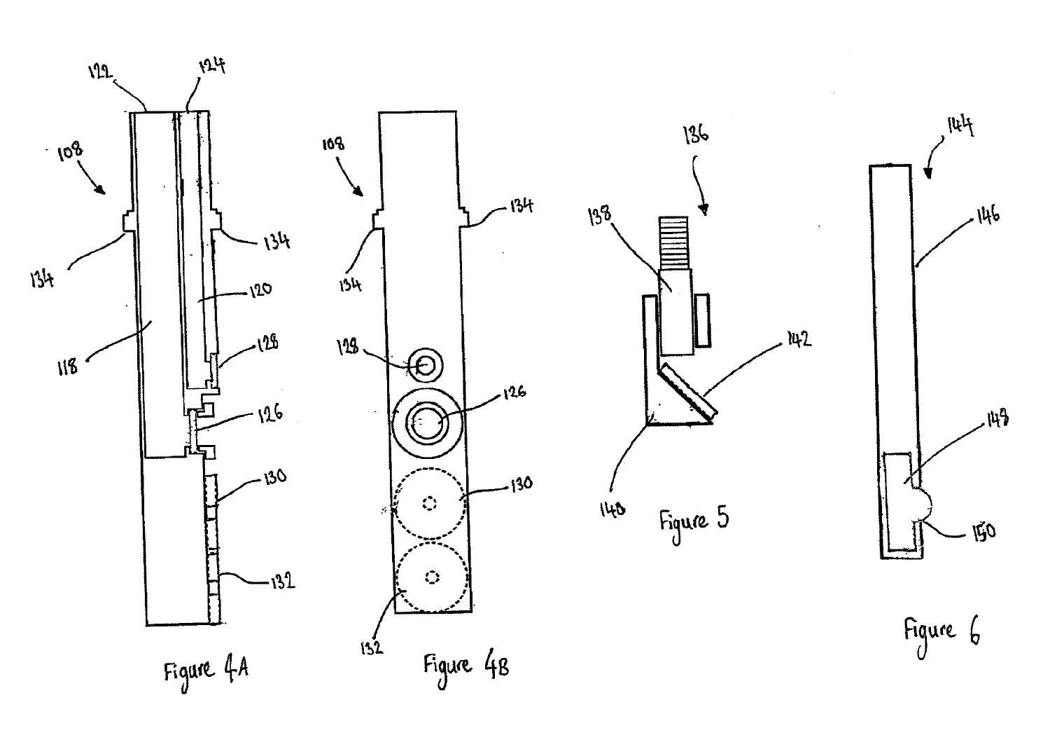

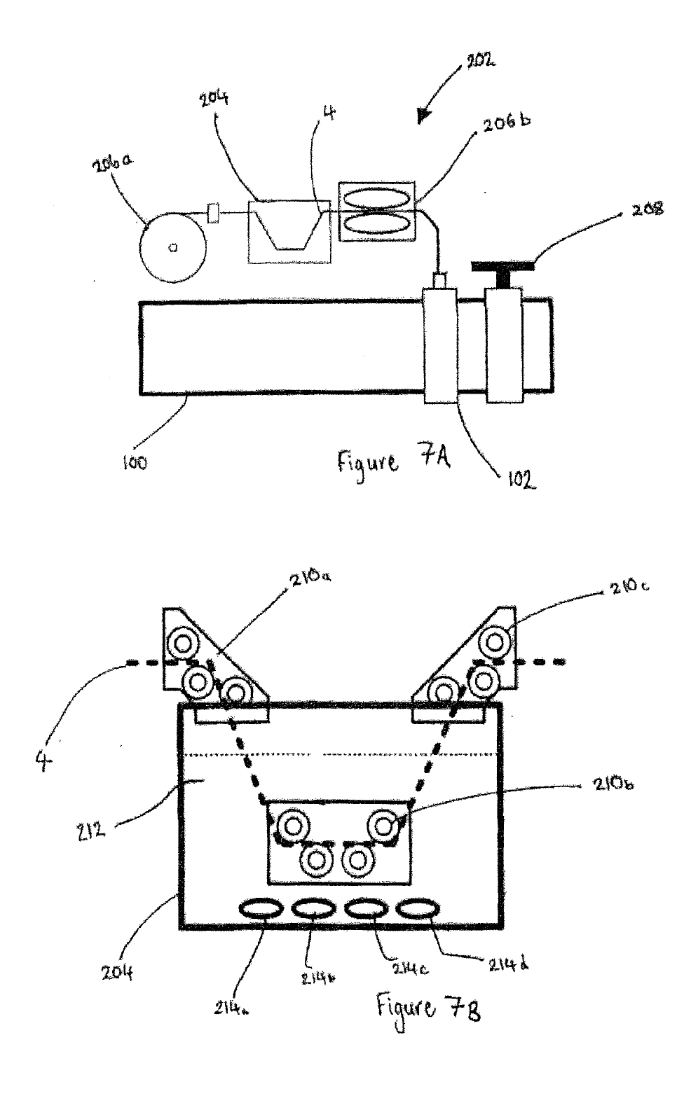

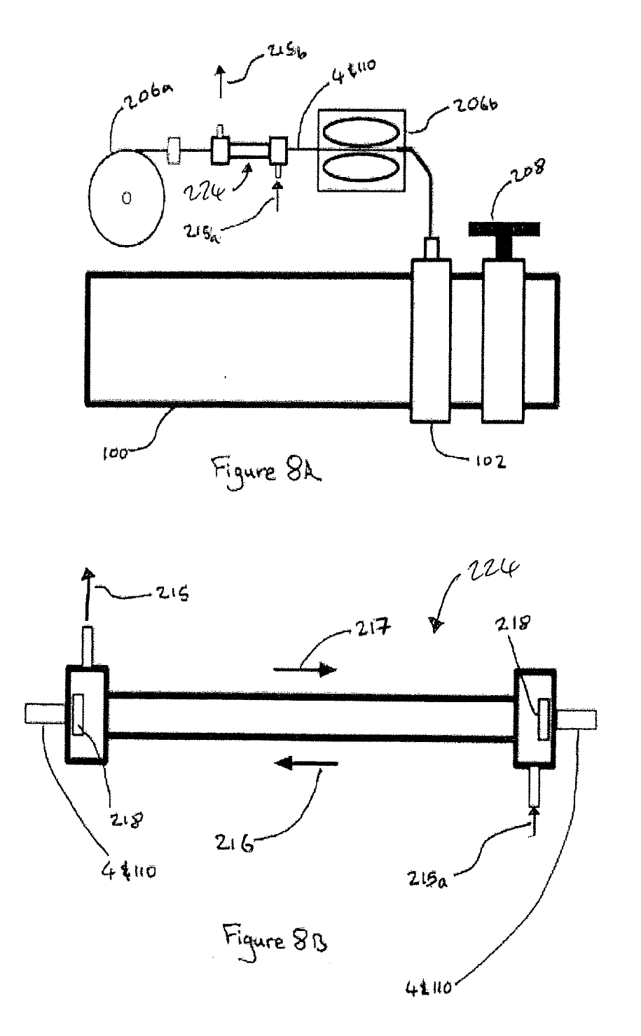

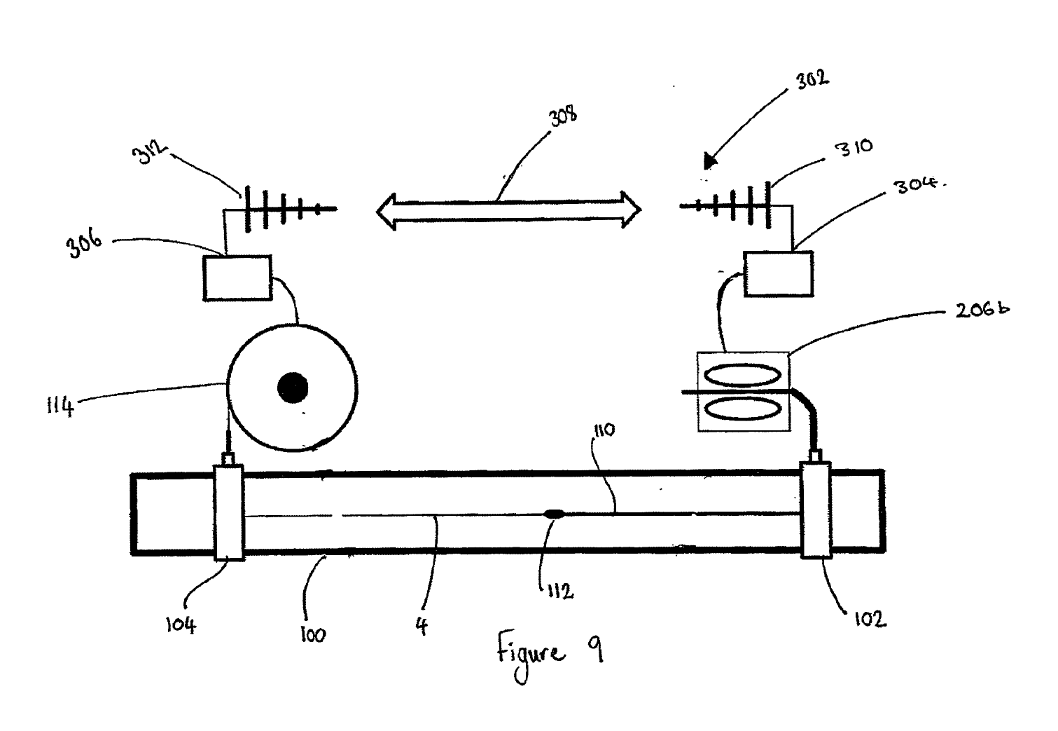

FIGS. 4A-6 are cross-sectional views of an embodiment of an extraction member in accordance with an aspect of the present invention;

FIGS. 7A-7B are schematic side cross-sectional views of embodiments of the system of the present invention provided with a sterilisation chamber;

FIGS. 8A-8B are schematic side cross-sectional views of embodiments of the system of the present invention provided with an alternative form of sterilisation chamber;

FIG. 9 is a schematic side cross-sectional view of a further embodiment of the system of the present invention;

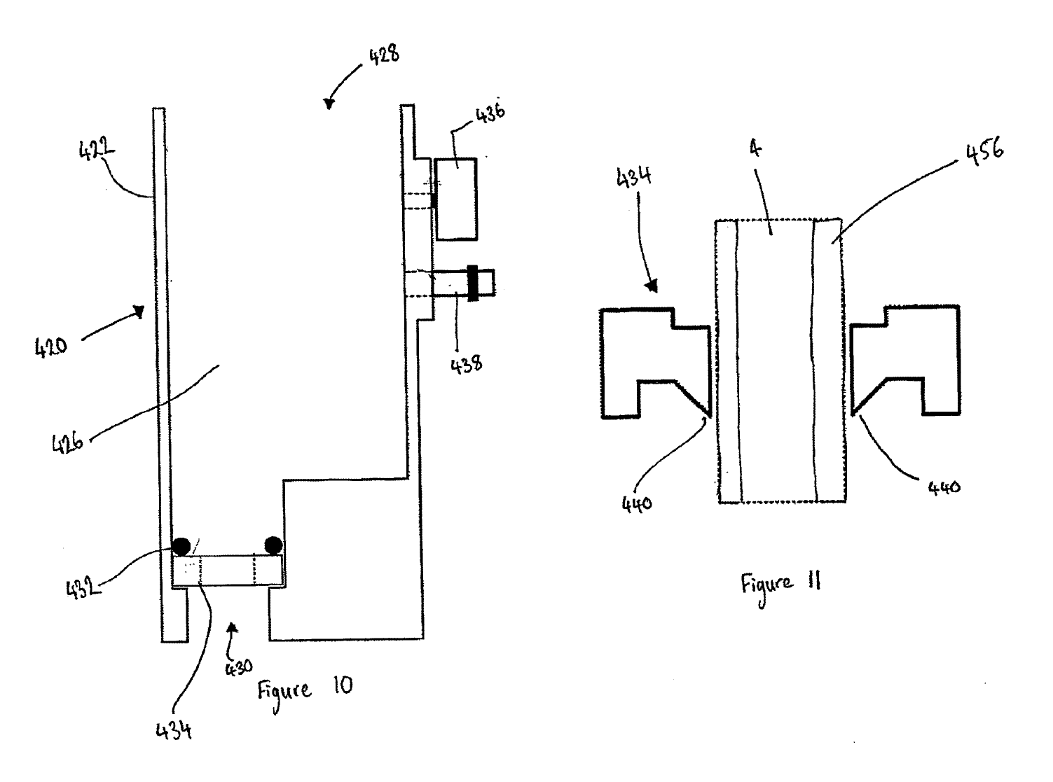

FIGS. 10-12 are side cross-sectional views of parts of an embodiment of a pressure chamber for use in a system in accordance with an aspect of the present invention; and

FIGS. 13A-13B are cross-sectional views of an embodiment of a connector fitting for use in a system in accordance with an aspect of the present invention.

FIG. 1 illustrates a section of a system 2 in accordance with an aspect of the present invention which includes a draw wire 4 and a sail structure 6. The system 2 further includes an annular stiffening ring 8, a first set of supporting arms 10 and a second set of supporting arms 12. In addition, the system 2 includes a means for extraction of the draw line 4 during operation in the form of magnetic end cap 14, a transmitter in the form of a micro-sonde 16 and a floatation ball 18.

As shown in FIG. 1, the sail structure 6 is constructed and arranged such that it is arranged in a substantially conical shape. At the apex of the conical shaped structure 6 there is provided an aperture 20, the purpose of which will be described herein below.

The sail structure 6 is shown as being connected to each of the supporting arms making up the first set of supporting arms 10, which are configured such that they have a complimentary shape to the sail structure 6. To achieve this, each of the supporting arms are connected at a first end to the other supporting arms making up the first set 10, and are connected at a second end to the annular stiffening ring 8. The result of such a configuration is that the sail structure 6 defines a hollow conical shape having an open base which is defined by the annular stiffening ring 8. The sail structure 6 therefore provides a structure which may be acted upon by fluid flow, in use.

The second set of supporting arms 12 are constructed and arranged in a similar fashion to the first set 10 as described above, with each of the supporting arms being connected at a first end to the other supporting arms making up the second set 12, and are connected at a second end to the annular stiffening ring 8. However, the sail structure 6 is not connected to the second set of supporting arms 12.

At a first end of the draw wire 4, on the left hand side of the sail structure 6 in the orientation shown in FIG. 1, the illustrated system 2 includes the magnetic end cap 14. This end cap 14 comprises part of an extraction mechanism which will be described herinbelow. In addition, the first end of the draw wire 4 includes the floatation ball 18 which aids the buoyancy of the system within the fluid flowing through a relevant pipe, in use. However, the use of floatation ball 18 is optional and will be dependent on the buoyancy of the system 2 as a whole which may differ depending on the components which it comprises. Likewise, more floatation balls may be used at other points along the draw wire 4 if necessary. On the opposing side of the sail structure 6, the draw wire 4 includes the micro-sonde 16.

The operational use of a system 2 which includes the section of the system illustrated in FIG. 1 will now be described with additional reference to FIGS. 2, 3A, 3B, 3C and 3D.

FIG. 3A shows a pipe 100 through which one or more elongate flexible members are placed using a method in accordance with the present invention. The pipe 100 may be any fluid pipe. As shown in FIG. 3A, the pipe 100 comprises a first connector fitting 102 at a first end of the pipe, and a second connector fitting 104 at a second end of the pipe which is downstream of the first. In some embodiments of the invention, the method may comprise installing the first and/or second connector fittings 102, 104 in position.

Initially, the fluid pressure within the pipe 100 is substantially equalised to the air pressure within the first connector fitting 102. If this step is not taken, fluid could be expelled from the pipe under pressure. This is at least undesirable and may be dangerous. This balancing of pressures may be performed using a pressure chamber which in some embodiments forms part of the first connector fitting 102. Alternatively, the pressure chamber may be an additional component (See FIGS. 10 to 12). It is noted that a similar procedure is undertaken at the second connector fitting 104 in order to access the interior of the pipe 100, when required.

Subsequent to balancing the pressures, the draw wire 4 is inserted through an opening (not shown) within the first connector fitting 102. The opening is dimensioned to allow the magnetic end cap 14, micro-sonde 16, first and second sets of supporting arms 10, 12, stiffening ring 8 and sail structure 6 to be passed therethrough.

In the illustrated embodiment the sail structure 6, stiffening ring 8 and sets of supporting arms 10, 12 are somewhat wider than the opening. However, to overcome this issue, the sail structure 6 is operable to be collapsed under the operation of the sets of supporting arms 10, 12 and stiffening ring 8 when passing through the opening.

To achieve this, the first set of supporting arms 10 is configured to act upon the annular stiffening ring 8 upon application of a force in an inward direction, i.e. towards the axis defined by the draw wire 4. This inward force is provided by means of contact of at least one of the supporting arms making up the first set 10 with a portion of the pipe 100 first connector fitting 102 which defines the opening. In doing so, the sail structure 6, along with the supporting arm sets 10, 12 and annular stiffening ring 8 are moved to a generally elongate configuration which is able to be passed through the opening.

The collapsed configuration of the sail structure 6 is shown schematically in FIG. 2. In particular, the supporting arms 12 are adapted to be slidably and flexibly connected to the draw wire 4 and the supporting arms 10 are adapted to be flexibly attached to the draw wire 4. Similarly, the annular stiffing ring 8 may be adapted to fold at points where it is connected to the supporting arms 10, 12. This allows the sail structure 6 to be collapsed where necessary, easing the task of inserting/extracting the sail structure from a pipe. In one preferred embodiment, the arms 10, 12 and/or stiffening ring 8 are adapted to provide a biasing force urging the sail structure 6 to the open configuration of FIG. 1.

Once the sail structure 6, supporting arm sets 10, 12 and stiffening ring 8 are fully passed through the opening in the first connector fitting 102 and are entirely within the interior of the pipe 100, the inward force provided by the contact with the pipe 100/connector fitting 102 is removed and the sail structure 6 returns to an expanded configuration, as shown in FIG. 3B. At this point, the fluid flow within the pipe 100 acts upon the inner face of the sail structure 6 which acts to move the draw wire 4 along the pipe 100 in a direction from the first connector fitting 102 towards the second connector fitting 104. The draw wire 4 is unreeled from wire reel 106 as the wire 4 moves along the pipe 100 as shown.

At the second connector fitting 104, the illustrated embodiment includes inserting an extraction member 108 through an opening (not shown) within the second connector fitting 104 such that it is entered into the interior of the pipe 100. As mentioned above, the fluid pressure within the pipe 100 and the air pressure within the second connector fitting 104 must be equalised before this takes place.

The extraction member 108 may comprise a magnetic material and in this way once the magnetic end cap 14 on draw wire 4 has been moved to the region in the pipe 100 proximal to the second connector fitting 104, the extraction member 108, through magnetic engagement with the end cap 14, may be used to withdraw the end of the draw wire 14 from within the pipe 100 through the opening in the second connector fitting 104. The illustrated method additionally comprises monitoring the position of the draw wire 4 within the pipe 100 using micro-sonde 16.

Subsequent to withdrawing the end draw wire 4 from within the pipe 100, including the sail structure 6, the free end of the draw wire 4 may be attached to a pulling mechanism 114 as shown in FIG. 3C. The pulling mechanism 114 continues the movement of the draw wire along the pipe 100 even after removal of the sail structure 6 from within the pipe 100. At the other end of the draw wire 4 to the free end which is attached to pulling mechanism 114, a first end of an elongate flexible member in the form of a micro-duct 110 is attached thereto as shown in FIG. 3C. The micro-duct 110 is reeled on a pushing mechanism 116, which in conjunction with the pulling mechanism 114 acting on the draw wire 4, acts to move the attached micro-duct 110 along the pipe 100 in a direction from the first connector fitting 102 towards the second connector fitting 104. As with the draw wire 4, the micro-duct 110 is provided with a further micro-sonde 112 which may be used to track the progress of the micro-duct 110 along the pipe as shown in FIG. 3C.

The first end of the micro-duct 110 is then withdrawn automatically from within the pipe 100 under operation of the push mechanism 116 and pull mechanism 114 without any further input. Once withdrawn at the second connector fitting 104, the first end of the micro-duct 110 may then be connected up with a street cabinet/exchange point or similar for use.

To complete the process, the method may additionally comprise sealing the openings within the first and second connector fittings 102, 104 around the portion of the micro-duct 110 which is located at these openings. Once the openings have been fully sealed it is no longer necessary to balance the fluid pressure within the pipe 100 with the air pressure within the connector fittings 102, 104 and therefore any external pressure chambers may be removed.

Subsequent to the process illustrated in these Figures, the method may additionally comprise blowing one or more cables or the like along the installed micro-duct. Such a process may be undertaken using any conventional blowing techniques which are well known in the art.

FIGS. 3A to 3D illustrate the process in accordance with the invention of laying a single micro-duct 110 along a length of pipe 100. It should however be appreciated that this process is not limited to a single micro-duct, nor is it limited to micro-ducts. In fact, any elongate flexible member may be used in place of the illustrated micro-duct 110.

FIGS. 4A, 4B, 5 and 6 illustrate the extraction member 108 in further detail. As shown in FIG. 4A, the extraction member 108 comprises a body having a first bore 118 and a second bore 120, the bores extending partly through the body of the extraction member 108. Each of the bores 118, 120 includes an open upper end 122, 124 and a lens 126, 128, the lenses 126, 128 being located at the distal end of the corresponding bore 118, 120 to the open upper end 122, 124. In addition to bores 118, 120, the extraction member includes first and second magnetic surfaces 130, 132, and an annular projection 134 for resting on the surface of a pipe in use to prevent the extraction member 108 from being inserted too far into the pipe.

The first bore 118 of the extraction member 108 is operable in use to receive a CCTV endoscope mechanism, which is illustrated schematically in FIG. 5. As illustrated, the CCTV endoscope mechanism includes a CCTV endoscope 138, a mounting device 140 and a mirror 142. In use, the mounting device 140 is located within the first bore 118 within the extraction member 108 in close proximity to the lens 126. The endoscope 138 itself is operable to be passed through the bore 118 towards the mounting device 140. The mirror 142 acts to direct light passing through the lens 126 onto the endoscope 138 when the endoscope 138 is positioned in the configuration shown in FIG. 5, i.e. directly above the mirror 142. In use, the endoscope mechanism is used to view along the pipe 100 from outside of the pipe 100.

The second bore 120 of the extraction member 108 is operable in use to receive an LED illumination mechanism, which is illustrated schematically in FIG. 6. As illustrated, the LED illumination mechanism includes an illumination rod 146 and an LED 148. The rod 146 includes an aperture 150 through which the LED 148 is shone in use. In use, the illumination rod 146 is located within the second bore 120 within the extraction member 108 with the LED 148 being positioned in close proximity to the lens 128. In this way, the LED 148 may be used to illuminate the interior of the pipe 100.

As stated above, the extraction member 108 also includes first and second magnetic surfaces 130, 132. These surfaces 130, 132 are operable in use to interact and magnetically connect to the magnetic cap 14 on the sail structure 6.

The configuration of the extraction member 108 as described above allows for the member 108 to be used to view a draw wire as it is moved along a pipe, and subsequently connect with the draw wire to remove the wire from within the pipe as required. This is achieved as the light from the illumination means (LED 148) is directed through the lens 128 down the pipe 100 and the light from within the pipe 100 is directed through the lens 126 and via the mirror 142 onto the endoscope 138. Viewing the draw wire in this manner allows a user to easily direct the extraction member 108 to attach it to the draw wire through the magnetic connection with the sail structure 6 (as described above).

FIGS. 7A & 7B and show a further embodiment of a system 202 in accordance with the present invention. The system 202 includes a number of identical features to the system 2 illustrated in FIGS. 1 to 6, and therefore like numerals have been used to identify like components. The system 202 additionally comprises a sterilisation chamber 204 for sterilising the draw wire 4 and/or flexible member 110 as it is introduced into the pipe. This is desirable when inserting flexible members into pipes 100 which may usually be used to transport fresh water as without such sterilisation, the fresh water within the pipe 100 may become contaminated. The operational use of the sterilisation chamber 204 will be described in further detail hereinbelow.

In addition to the sterilisation chamber 204, the system 202 includes a stop tap 208 on the pipe 100 for preventing fluid flow along the pipe if required. The system 202 also differs from system 2 in that the wire reel 106 and push mechanism 116 are replaced by a reel 206a located at one side of the sterilisation chamber 204, and a push mechanism 206b at the other side of the sterilisation chamber 204.

The sterilisation chamber 204 includes a series of pulley mechanisms 210a, 210b, 210c which guide the draw wire 4 (or subsequently a flexible member 110) through the sterilisation chamber 204. Pulley mechanisms 210a, 210c are located outside of the chamber and act to direct the draw wire 4 into the chamber 204 and out of the chamber 204, respectively. Pulley mechanism 201b is located within the sterilisation chamber 204 and acts to move the draw wire 4 along the chamber 204 in a desired direction. This is shown schematically in FIG. 8.

In use, the chamber 204 is filled with a fluid 212, usually water, to such a level that the draw wire 4 is completely submerged within the chamber 204. To provide the sterilisation, the fluid 212 is supplied with oxygen enriched with O₃ molecules, commonly termed ‘ozone gas’. Ozone gas is a very powerful oxidant with an instant action and so provides sterilisation in a very short time. To provide the ozone gas, the chamber 204 includes a series of ozone ‘bubblers’ 214a, 214b, 214c, 214d located along a bottom surface of the chamber 204 in close proximity to the draw wire 4 when it is passed therethrough.

In a further embodiment of the system for sterilisation, such sterilisation may be accomplished by the means of the flow of dry ozone gas over the member to be sterilised, as is shown in FIGS. 8A & 8B. In this embodiment, the sterilisation chamber 224 is adapted to enable the draw wire 4 and/or flexible member 110 to pass through as it is introduced into the pipe 100. The chamber comprises an ozone inlet 215a and an ozone outlet 215b. This enables a flow of ozone gas to be set up in a direction 216 that is the reverse of the direction 217 in which the draw wire 4 or member 110 traverses the chamber 224. The chamber 224 may be provided with lip seals 218 or similar to minimise the egress of ozone gas, ensuring that said gas is exhausted safely via outlet 215b to a remote place.

The pull mechanism 206b acts, either alone or in combination with the action of the sail surface 6, to pull the draw wire 4 off the wire reel 206a, through the sterilisation chamber 204 and subsequently into the pipe 100.

FIG. 9 illustrates a further embodiment of a system 302 in accordance with the present invention. As with system 202, system 302 includes many components which are identical to system 2. Therefore like numerals have been used to identify components which are deemed to be equivalent in all systems.

System 302 differs from the preceding systems in that it also includes a means for the push mechanism 206b or 116 to communicate with the pull mechanism 114 to coordinate the pushing/pulling of the draw wire 4 or flexible member 110 through the pipe 100. In the illustrated embodiment, this communication is done over a wireless connection 308. To enable communication over the wireless connection 308, each of the push/pull mechanisms 114, 116, 206b are suitably connected to a transceiver 310, 312 for transmitting/receiving information over the connection 308. In order to control the information which is transmitted over the connection 308, and also the operation of each push/pull mechanism 114, 116, 206b, the mechanisms are each provided with a control box 304, 306. The control boxes 304, 306 are operable in use to process information received from the other box 306, 304 and adjust the speed at which the corresponding push/pull mechanism 114, 116, 206b is operating accordingly.

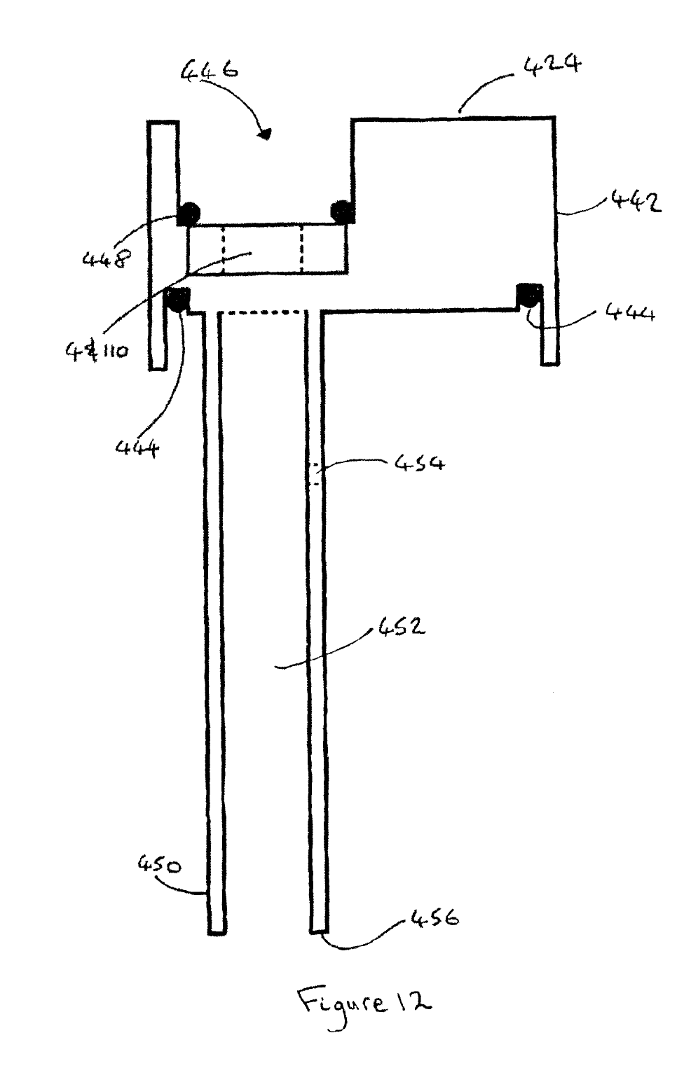

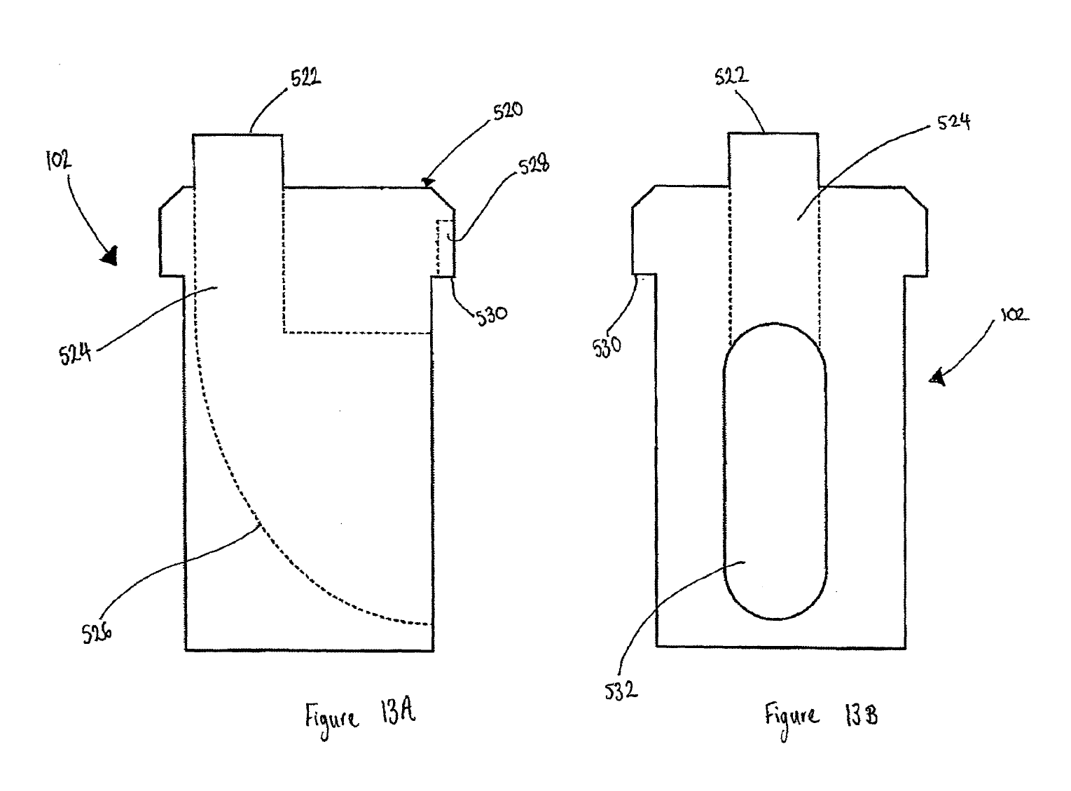

An embodiment of an external pressure chamber 420 is illustrated in further detail in FIGS. 10 to 12. The pressure chamber 420 includes a housing 422 (shown in FIG. 10) and a lid portion 424 (shown in FIG. 12). The housing 422 includes a central cavity 426 having an open upper end 428 and open lower end 430. The chamber housing 422 is configured such that the central cavity has a first section having a first, larger diameter proximal to the open upper end 428 and a second section having a second, smaller diameter proximal to the open lower end 430. The open lower end 430 further comprises an o-ring seal 432 and also a lip seal assembly 434, which is illustrated further in FIG. 11. The purpose of the seals is to provide a fluid-tight barrier to any fluid from within the pipe being expelled out of the pipe, or likewise any fluid within the chamber entering the pipe. As shown in FIG. 11, the lip seal assembly 434 comprises a generally cylindrical configuration and has a bore therethrough which is configured to allow a lower portion 456 of the lid 424 to be introduced therein. The lower surface 440 of the lip seal assembly 434 is tapered in such a way that as the pressure applied to the lip seal assembly 434 increases the sealing force increases as the pressure applied to the lower surface 440 acts to reduce the diameter of the bore.

The chamber housing 422 also includes a pressurisation port 438 operable in use to allow for the introduction of removal of gas from within the chamber housing 422 in order to equalise the pressure therein, and a pressure meter 436 for monitoring the pressure within the housing 422. The equalisation process may be fully automated.

The lid portion 424 of the pressure chamber 420 is shown schematically in FIG. 12. The lid portion 424 includes an upper portion 442 which has a slightly larger diameter than the open upper end 428 of the housing 422. In this way, the lid portion 424 may be placed over the open upper end 428 and securely fastened thereto. To ensure no fluid may escape from within the housing 422 through the open upper end 428, the lid portion further includes an o-ring seal 444 provided a fluid-tight seal between the housing 422 and the lid portion 424. The upper portion 442 of the lid 424 also includes an opening 446 therein for connecting a further component of the system 2, 202, 302 thereto. This further component may comprise a push/pull mechanism 114, 116, 206b for example. The opening 446 also includes an o-ring seal for a fluid-tight seal between the lid portion 424 and the further component to prevent any unwanted fluid loss/drop in pressure.

The lid portion 424 further includes a lower extended portion 450 which has a much smaller diameter to the housing 422. The lower extended portion 450 is configured such that a lower portion 456 of the extended portion 450 is inserted through the bore in the lip seal assembly 434 at the lower end 430 of the housing 422 when the lid portion 424 is securely fastened to the housing 422. The extended portion 450 of the lid portion 424 also includes a bore 452 running therethrough, along with a fluid inlet 454 allowing introduction or removal of fluid from within the bore 452 to control the pressure therein. The bore 452 has a lower open end and an upper end which is located within the upper portion 442, and in particular is located at the opening 446 within the upper portion 442. In this way, a draw wire 4 or other flexible member may be introduced through the opening 446 in the upper end of the lid 424, along the bore 452 and through the lower open end 456 of the bore 452 either directly into the pipe 100 or into a further component of the system 2, 202, 302 such as a first or second connector fitting 102, 104.

An embodiment of a connector fitting 102 is shown schematically in FIGS. 13A and 13B. The connector fitting 102 includes an open upper end 522 for introduction of a draw wire 4, flexible member 110 or even the lower end 456 of a pressure chamber therein. The connector fitting 102 includes a stepped configuration having a first portion having a first diameter and a second portion having a second, larger diameter. The step 530 in the connector fitting 102 is operable in use to securely fasten the connector fitting either directly onto the pipe, or to another component of the system 2, 202, 302. Furthermore, in the illustrated embodiment, the connector fitting 102 include a spigot recess, allowing for rotational location of the connector fitting into position within the pipe 100.

In use, the first portion of the connector fitting 102 is located within the pipe 100 and acts to guide the draw wire 4 or flexible member 110 into the interior of the pipe 100. To do so, the illustrated connector fitting further includes a bore 522 having a sloped lower section 526 and a lower opening 532 at the distal end of the bore 522 from the open upper end 522 of the connector fitting 102. The lower opening 532 in the connector fitting 102 allows for the draw wire 4 or flexible member 110 to be passed along the bore 522 and into the pipe 100. The sloped lower section 526 of the bore 522 acts to urge the wire 4 or member 110 to a horizontal position for passing along the pipe 100.

Whilst the embodiment illustrated in FIGS. 13A and 13B is described as being a first connector fitting 102, it is equally suited to being a second connector fitting 104 at the second point on the pipe 100.

The above embodiment is described by way of example only. Many variations are possible without departing from the scope of the invention as defined in the appended claims.

1-39. (canceled)

40. A method of laying one or more elongate flexible members through a fluid pipe comprising the steps of:
a) inserting a first end of draw wire into the fluid pipe through a first opening in the fluid pipe;
b) allowing the draw wire to travel along the pipe under the influence of the fluid flow through the pipe;
c) withdrawing the first end of the draw wire from the pipe through a second opening in the pipe such that the first end of the draw wire is located at the second opening, outside of the pipe; a second end of the draw wire which is located at the first aperture, outside of the pipe; and an intermediary portion of the draw wire is located between the first and second ends of the wire within the pipe;
d) attaching a first end of the or each elongate flexible member to the second end of the draw wire; and
e) moving the draw wire through the pipe in a direction from the first opening towards the second opening to transfer the or each elongate flexible member through the pipe and subsequently out of the pipe through the second opening such that the or each elongate flexible member has a first end which is located at the second opening, outside of the pipe; an intermediary portion located within the pipe between the first and second openings; and the remainder of the or each elongate member is located at the first opening, outside of the pipe.

41. A method as claimed in claim 40 wherein the draw wire is provided with a sail structure attached to or integrally formed with the draw wire and positioned at an angle to the direction of fluid flow along the pipe, and the method comprises allowing the draw wire to move along the length of the pipe by means of the fluid within the pipe acting on said sail structure.

42. A method as claimed in claim 41 comprising collapsing the sail structure from an expanded configuration to a collapsed configuration in order to insert or remove it from the pipe through the first and/or second openings.

43. A method as claimed in claim 40 wherein withdrawing the first end of the draw wire from within the pipe through the second opening is achieved under the operation of a withdrawal means, the withdrawal means comprising an extraction member and the method comprises inserting the extraction member through the second opening and subsequently engaging a portion of the draw wire to connect therewith for withdrawal of the first end of the draw wire from the interior of the pipe.

44. A method as claimed in claim 40 further comprising installing one or more connector fittings on the pipe, each connector fitting providing the first and/or second openings in the pipe.

45. A method as claimed in claim 44 wherein the or each connector fitting comprises a pressure chamber and the method further comprises utilising the or each pressure chamber to equalise the fluid pressure within the pipe to the air pressure within the connector fitting.

46. A method of claim 40 wherein the method comprises monitoring the position of the draw wire as it is allowed to move along the length of the fluid pipe.

47. A method as claimed in claim 40 wherein at least one of the one or more elongate flexible members comprises a micro-duct, and the method further comprises the step of introducing at least one cable into the or each micro-duct subsequent to step e).

48. A sail structure for use in the method of claim 40 comprising a surface attached to or integrally formed with the draw wire and which in use is positioned at an angle to the direction of fluid flow along the pipe, wherein the sail structure is moveable between a collapsed configuration and an expanded configuration.

49. A structure as claimed in claim 48 wherein the sail structure is retained in its expanded configuration under the operation of a biasing means.

50. An extraction member for use in the method as claimed in claim 40 comprising a body which is operable in use to be inserted through the second opening in the pipe, the body having a surface thereon operable to engage a portion of the draw wire and/or sail structure for subsequent withdrawal of the first end of the draw wire from within the interior of the pipe.

51. An extraction member as claimed in claim 50 wherein the surface of the member comprises a magnet or series of magnets and the draw wire and/or sail structure comprises a portion which is formed of a magnetic material.

52. An extraction member as claimed in claim 50 additionally comprising a means to view along the length of the pipe when it is inserted through the second opening; or additionally comprising an illumination means.

53. An extraction member as claimed in claim 52 comprising at least one bore dimensioned to receive either the viewing means or the illumination means.

54. A connector fitting for use in a method as claimed in claim 40 comprising an attachment means adapted to attach to a surface of the fluid pipe about an opening within the pipe; and a sealing means for providing a watertight seal around the opening.

55. A connector fitting as claimed in claim 54 operable in use to allow for the introduction or removal of a draw wire and/or one or more elongate flexible members into or out of the interior of the pipe through the opening in the pipe, wherein the sealing means is operable to maintain the watertight seal once the draw wire and/or one or more elongate flexible members have been introduced/removed from the pipe, and/or during the introduction or removal of the draw wire and/or one or more elongate flexible members.

56. A connector fitting as claimed in claim 55 additionally comprising a pressure chamber, wherein the pressure chamber is operable in use to equalise the fluid pressure within the pipe to the air pressure within the connector fitting.

57. A kit of parts for performing the method of laying one or more elongate flexible members through a fluid pipe as claimed in claim 40 comprising; a sail structure comprising a surface attached to or integrally formed with the draw wire and which in use is positioned at an angle to the direction of fluid flow along the pipe, wherein the sail structure is moveable between a collapsed configuration and an expanded configuration; and a draw wire.

58. A kit of parts as claimed in claim 57 further comprising a means to withdraw the first end of the draw wire from within the pipe at the second opening of a pipe, in use, wherein the withdrawal means comprises an extraction member, said extraction member comprising a body which is operable in use to be inserted through the second opening in the pipe, the body having a surface thereon operable to engage a portion of the draw wire and/or sail structure for subsequent withdrawal of the first end of the draw wire from within the interior of the pipe.

59. A kit of parts as claimed in claim 58 further comprising an insertion mechanism, wherein the insertion mechanism comprises a transmitter.
